(19) United States
(12) Patent Application Publication
(10) Pub. No.: US 2026/0178773 A1
(43) Pub. Date: Jun. 25, 2026

(54) DIGITAL VAULT FOR STORING PRACTICAL AND PERSONAL INFORMATION FOR PASSING TO SELECTED INDIVIDUALS

(71) Applicant: WonderVault LLC, Coeur d'Alene, ID (US)

(72) Inventors: Warren Heit, Coeur d'Alene, ID (US); Brian Marcus, Mill Valley, CA (US)

(73) Assignee: WonderVault, LLC, Coeur d'Alene, ID (US)

(21) Appl. No.: 19/429,593

(22) Filed: Dec. 22, 2025

Related U.S. Application Data
(60) Provisional application No. 63/737,760, filed on Dec. 22, 2024.

(51) Int. Cl. G06F 21/62; G06F 21/60

(52) U.S. Cl. CPC G06F 21/6245; G06F 21/604

(57) ABSTRACT

A secure digital vault system allows users store various types of practical information, as well as personal mementos throughout their lifetime. Upon the user's passing (or a chosen transfer time), the contents of the vault are transferred to designated recipients.

### PRIORITY CLAIM

The present application claims priority to U.S. Provisional Patent Application No. 63/737,760, entitled, “DIGITAL VAULT FOR STORING PRACTICAL AND PERSONAL INFORMATION FOR PASSING TO SELECTED INDIVIDUALS,” filed on Dec. 22, 2024, which application is incorporated herein by reference in its entirety.

### FIELD

The present technology relates generally to digital storage systems, and more specifically to a system and method for a digital vault capable of securely storing practical information and personal mementos throughout a user's lifetime and transferring this information to designated recipients at the time of the user's choosing.

### BACKGROUND

In the modern digital era, individuals amass a significant collection of both practical information and deeply personal mementos. Practical information may include important details such as passwords, financial account information, asset documentation, and legal documents like wills. Personal mementos often comprise photographs, writings, advice, and other sentimental artifacts that capture the essence of an individual's life and values.

Despite the availability of digital storage solutions, challenges persist in ensuring the efficient and comprehensive transfer of this information and these mementos to loved ones, for example upon the owner's death. Many people pass away without having adequately planned or facilitated the transfer of such materials. As a result, loved ones often face unnecessary difficulties, including the inability to access critical information or the loss of sentimental items, leaving an emotional and logistical void.

### DESCRIPTION OF THE DRAWINGS

FIG. 1 is a schematic representation of a digital vault system according to embodiments of the present technology.

FIG. 2 is an illustration of a client device including a graphical user interface implementing an application according to embodiments of the present technology.

FIG. 3 is a flowchart showing a method for setting up and transferring a digital vault according to embodiments of the present technology.

FIG. 4 is a flowchart showing additional detail of step 200 for setting up the vault transfer.

FIG. 5 is a schematic block diagram of a computing environment according to embodiments of the present technology.

FIGS. 6-23 are screen shots of various user interfaces presented by the present technology.

### DETAILED DESCRIPTION

The present technology will now be described with reference to the figures, which in general relate to a secure digital vault system accessible via a smartphone application or website. The system allows users to store various types of practical information, including but not limited to financial records, wills, and passwords, as well as personal mementos, such as journals, photos, videos, and life advice. The system allows users to build a rich collection of practical information and sentimental artifacts throughout their lifetime. Upon the user's passing (or a chosen transfer time), the contents of the vault are transferred to designated recipients.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

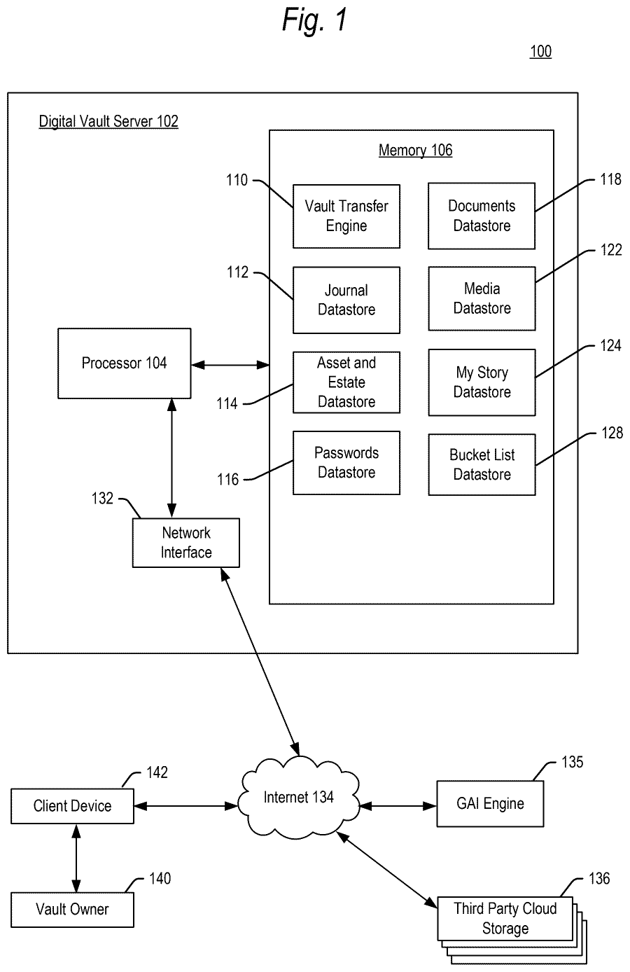

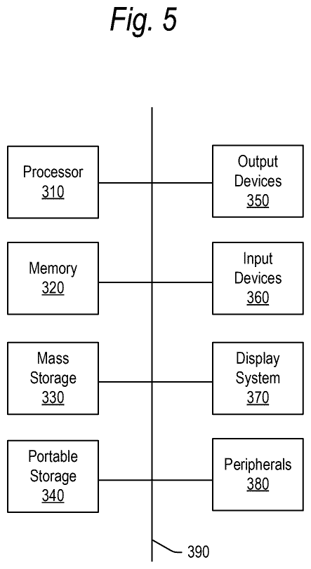

FIG. 1 is a schematic block diagram of a sample digital vault architecture 100 for implementing the present technology. Architecture 100 may include a server 102 owned or controlled by a digital vault service provider. In further embodiments, server 102 may be comprised of multiple servers, collocated or otherwise. A more detailed explanation of a sample server 102 is described below with reference to FIG. 5, but in general, server 102 may include a processor 104 configured to control the operations of server 102, as well as to facilitate communications between various components within server 102. The processor 104 may include a standardized processor, a specialized processor, a microprocessor, GPU or the like that may execute instructions for controlling server 102.

As explained below, processor 104 may be an AI processor capable of implementing generative AI functions including query responses. In further embodiments, the processor 104 may alternatively or additionally be in communication with a generative artificial intelligence engine 135 for performing a variety of functions, including query responses.

The server 102 may further include a memory 106 that may store algorithms that may be executed by the processor 104. According to an example embodiment, the memory 106 may include RAM, ROM, cache, flash memory, a hard disk, and/or any other suitable storage component. As shown in FIG. 1, in one embodiment, the memory 106 may be a separate component in communication with the processor 104, but the memory 106 may be integrated into the processor 104 in further embodiments.

Memory 106 may store various software application programs executed by the processor 104 for controlling the operation of the server 102. Such application programs may for example include a vault transfer engine 110 as explained below. Memory 106 may further include various datastores for use by the present technology, including a journal datastore 112, acid in the state datastore 114, password datastore 116, documents datastore 118, media datastore 122, “my story” datastore 124 and bucket list datastore 128. Each of these datastore's explained in greater detail below.

The server 102 may further include communications circuitry such as a network interface 132 for connecting to the Internet 134. The server 102 may include additional components for example as described below with respect to FIG. 5.

As mentioned, embodiments of the present technology use generative artificial intelligence (GAI), for example a large language model, to handle certain functions within the digital vault server 102. In embodiments, the processor 104 may be in communication with a GAI engine 134 via the Internet 124. In further embodiments, the GAI engine 134 may be integrated into the processor 104 of server 102 as noted above. GAI engine 134 receives an input, or prompt, and uses models and algorithms to generate an output including new, original content based on a given dataset on which engine 134 is trained. GAI engine 134 may be an existing generative neural network, such as GPT-3, GPT-4, or other known models. These models have been trained on extensive datasets and possess the ability to generate coherent and contextually relevant text based on provided input. In one example, the GAI engine 134 may be a large language model which may be trained and developed by the following steps.

Data Collection and Preprocessing: The GAI engine 134 may be provided with all of the data stored in an owner's vault including text, audio and video data. In further embodiments, the GAI engine may additionally or alternatively be provided with a diverse and extensive data set including a wide range of text from various sources, such as books, articles, websites, and more. The data may be preprocessed to ensure consistency, remove noise, and normalize the input format. The text may be broken down into smaller units, often words or subwords. Each unit may be assigned a unique identifier or token.

Model Architecture Selection: The GAI engine 134 may be configured in different model architectures, including for example a transformer architecture, generative adversarial network (GAN), a variational autoencoder (VAE), an autoregressive model, or other types of models designed for generative tasks. For large language models like GPT, the architecture is often based on the transformer architecture, which utilizes self-attention mechanisms. Self-attention mechanisms enable the model to weigh the importance of different words in a sequence when processing each word, allowing the model to capture relationships and dependencies between words more effectively.

Training the Model: The GAI engine 134 may then be trained using the prepared dataset. During training, the dataset may be divided into training, validation, and test sets. The training set is used to update the model parameters, the validation set is used to fine-tune hyperparameters and prevent overfitting, and the test set evaluates the model's generalization to unseen data. Using an optimization algorithm (e.g., stochastic gradient descent) the model parameters are iteratively updated based on the training data. The model is regularly evaluated based on the validation dataset to monitor its performance. The test set is used to assess the final performance and generalization of the model.

It is understood that the above steps for developing and training GAI engine 134 are by way of a summary example only and other or alternative steps may be used to develop and/or train a GAI engine 134 for use with the present technology. Where the processor 104 is an AI processor, the AI processor 104 may be trained in the same manner.

In use, a vault owner 140 may access the digital vault server 102 through the owner's client device 142. In one embodiment, the client device 142 may be a smart phone, tablet, laptop or desktop computer. In such embodiments, the vault owner may download a digital vault application on their smart device for implementing portions of the functionality of the present technology. In further embodiments, the application on the owner's client device 142 may implement all of the functionality of the present technology. In this further embodiment, the server 102 may be omitted. This embodiment has the advantage that all operations may take place on the user's client device 142 without an Internet connection, thus increasing security. In still further embodiments, the user's client device may execute a browser for accessing a website at server 102. In this embodiment, the server 102 may implement all functionality of the present technology.

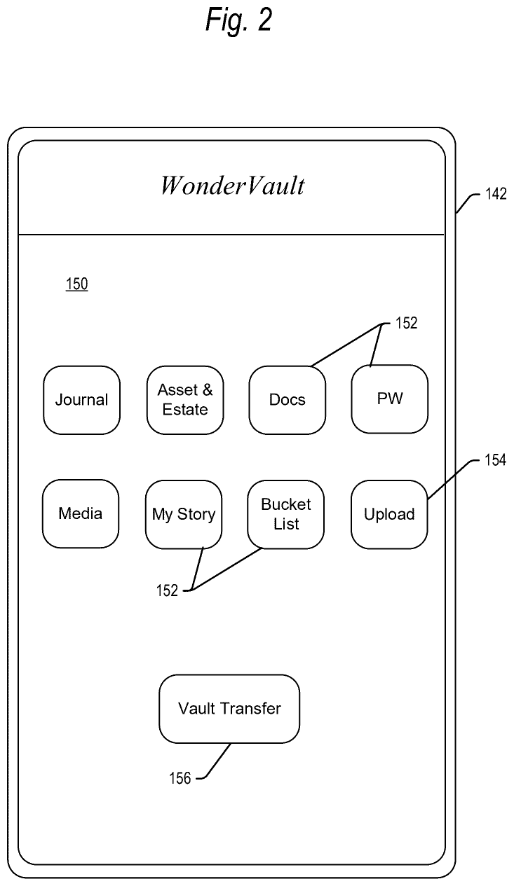

Using the client device 142, the vault owner 140 may upload a wide variety of information to the digital vault server 102, for example over a prolonged period of the owner's lifetime. In one example, this information may breakdown into two categories—practical information and personal or sentimental information. There may be more than two categories in further embodiments. Referring to FIG. 2, in use, a vault owner may be presented with a user interface (UI) 150 on the client device 142. The UI 150 is shown including a tradename, Wonder Vault, under which the digital vault application of the present technology is distributed. The UI 150 further includes a number of predefined icons 152, each representing a separate datastore into which the owner's practical and personal information may be stored. The icon classes are presented to help elicit information from the vault owner and to help the vault owner organize their information.

In the illustrated example, the UI 150 may include a journal icon 152. Upon clicking the journal icon, the user is presented with a new UI 150 allowing the owner to make textual (and possibly graphical) journal entries. The journal entries may relate to any subject the owner desires to expound on, but may include the owner's thoughts, reflections, desires and advice for the one or more beneficiaries. The owner 140 may save each journal entry to journal datastore 112 once created.

Another icon 152 allows the owner 140 to list information about all of their financial documents, including assets, estate documents such as wills and trusts, bank accounts, credit cards, loan and mortgage documents, brokerage and retirement accounts, tax returns, deeds and titles, business records and agreements, etc. This asset and estate information may be saved in the asset and estate datastore 114. Another icon 152 allows users to upload and save documents to the documents datastore 118, such as any of the financial documents mentioned above.

Another icon 152 allows users to store the passwords for their various accounts in passwords datastore 116. In order to protect this information, as well as the other sensitive financial information, the digital vault server 102 may be provided with a variety of security measures. These security measures include but are not limited to data encryption, network security and multi-factor and other authentication methods.

In order to protect sensitive practical information and personal content stored in the digital vault, the system may implement one or more layers of encryption and key management. As one example of security measures, when a user signs up for an account, a unique user seed is generated. The user seed may be generated locally on the user's client device, for example using a cryptographically secure random number generator. The user seed is used to derive one or more cryptographic keys, such as by applying a hashing function, key-derivation function, or combination thereof. In one embodiment, a hash derived from the user seed serves as, or is used to generate, an encryption key that is stored locally on the user's client device and is not transmitted in plaintext to the server.

The user seed may be stored in association with a list of authorized users in a secure data structure, such as a {seed, users} table, where a single seed may be associated with one or more users as a result of the vault transfer feature. Each piece of data added to the digital vault, whether practical information, personal information, documents, passwords, or multimedia files, may be encrypted using a cryptographic key derived from the user seed, such that data belonging to different vault owners is encrypted with different keys. As a result, even if encrypted data from multiple users is stored in the same database or datastore, the data remains cryptographically isolated on a per-user basis.

When a user elects to transfer their vault, either automatically on a predetermined date or manually upon verified death or incapacity, a designated recipient may receive a notification indicating that access has been granted. Upon successful verification of the transfer condition, the recipient may be added to the authorized users associated with the user seed. The {seed, users} table itself may be encrypted, for example using a master key that is owned or controlled by the vault owner, further limiting access to vault metadata.

In some embodiments, encryption and decryption of vault contents may occur primarily on the client device, such that encrypted data is transmitted to and stored on the server without the server ever having access to the plaintext data or the underlying encryption keys. In such embodiments, the server functions primarily as a secure storage and transfer facilitator. In other embodiments, encryption may be performed at the server using keys derived from user-specific material, optionally in combination with server-side secrets or hardware-based security modules. Hybrid approaches are also contemplated, where certain classes of data are encrypted locally on the client device while other classes of data are encrypted at the server.

In further embodiments, different cryptographic keys may be used for different classes of stored data, such as passwords, documents, journal entries, and multimedia files. In one example, a master key derived from the user seed may be used to encrypt one or more secondary keys, and those secondary keys may be used to encrypt individual files, records, or datastores. This approach allows selective revocation, re-encryption, or controlled sharing of subsets of vault contents without requiring re-encryption of the entire vault.

During a vault transfer event, cryptographic material associated with the vault may be re-wrapped, escrowed, or otherwise made accessible to one or more beneficiaries without exposing the underlying encryption keys to unauthorized parties. For example, upon verification of a transfer condition, a copy of an encrypted key or key-derivation component may be securely delivered to a beneficiary's client device, where it may be decrypted or reconstructed only after successful authentication of the beneficiary. This allows beneficiaries to gain access to encrypted vault contents while preserving cryptographic separation prior to the transfer event.

In embodiments, access to encryption keys may be bound to one or more authentication factors, including but not limited to passwords, biometric inputs, device credentials, or multi-factor authentication mechanisms. For example, decryption of vault contents may require both possession of the client device storing the user seed and successful completion of an authentication challenge. Such binding reduces the risk of unauthorized access even if encrypted data or key material is compromised.

The system may further support cryptographic key rotation, revocation, and recovery mechanisms. For example, a vault owner may periodically regenerate encryption keys derived from the user seed, with existing vault contents being re-encrypted automatically. In the event of device loss or replacement, recovery mechanisms may be provided that allow a user to reconstruct cryptographic keys using escrowed information, trusted contacts, or other secure recovery processes, without exposing plaintext vault contents to the service provider.

In embodiments where artificial intelligence or generative AI engines process vault data to generate summaries, stories, or responses, encryption controls may be applied to limit the scope of data provided to such engines. For example, decrypted data may be processed transiently in volatile memory and not persistently stored in decrypted form. In other embodiments, AI processing may be limited to client-side execution, or to encrypted representations of vault data, thereby preserving confidentiality while enabling AI-based functionality.

Another icon 152 allows users to upload photos, audio clips, video clips and other multimedia files and save them in the media datastore 122. The media icon allows the owner 140, over time, to upload photos, audio and video of the owner.

The interface 150 may further include a “my story” icon 152 where a user can create a story of their life, at once or over time, and save it in the my story datastore 124. Upon pressing the “my story” icon, a user may be presented with a word-processing interface where a user can enter text creating a story of their life. As noted, the digital vault 102 may have AI processing capabilities, either directly through processor 104, or through the Internet connection to GAI engine 134. Thus, in embodiments, instead of an owner manually creating their life story, their story may be automatically generated by the AI processing capabilities of the digital vault 102 using the information stored in their vault, such as for example using the information stored in the journal datastore 112 or other datastores.

The interface 150 may further include a bucket list icon 152. Upon selecting this icon, the owner is presented with a word processing interface where the owner can create a list of things the owner would like to do and/or places the owner would like to visit, in their lifetime. This information may be stored in the bucket list datastore 128.

The icons 152 shown in FIG. 2 are by way of example only, and the interface 150 may present other or additional icons, soliciting other types of information from the owner, in further embodiments. Moreover, while FIG. 1 shows separate datastores for each of the icons shown in FIG. 2, it is understood that the information provided upon accessing the icons 152 may be stored in memory 106 in a single datastore, or one or more separate datastores, in further embodiments.

FIG. 2 further shows an upload button 154. It may happen that the user has digital documents, photos, media, etc. stored on one or more third party cloud storage sites 136 (FIG. 1). Such third-party storage sites include for example Apple iCloud, Google Drive, Dropbox and Microsoft OneDrive. Upon selecting button 154, the user is given the option to access and copy/transfer files into their digital vault from one or more of these (or other) third-party cloud storage sites 136.

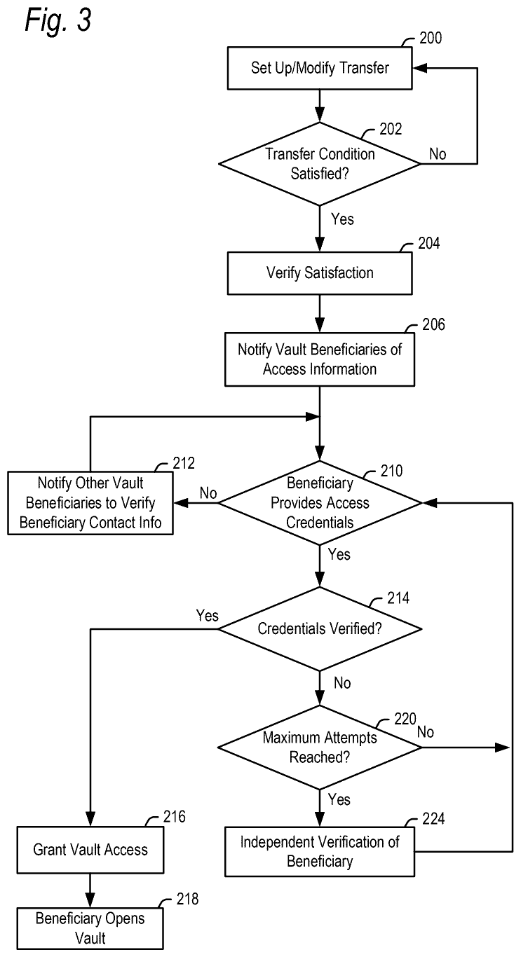

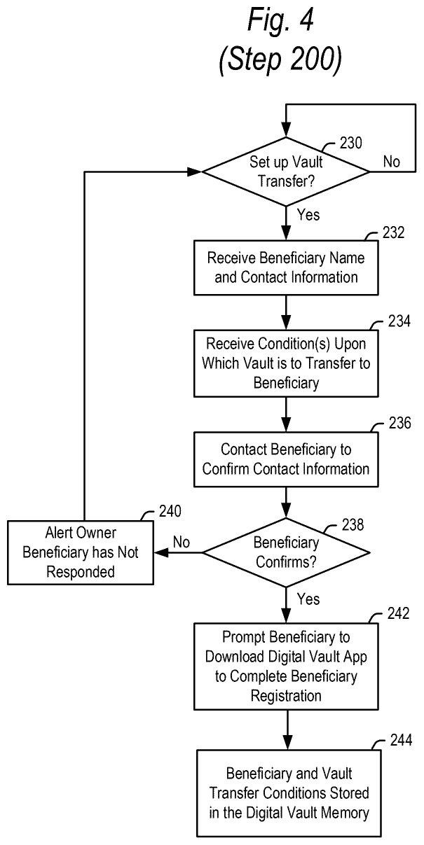

It is a feature of the present technology that the owner maintains exclusive control of their digital vault, and the ability to see and/or modify the contents of their digital vault until such time as the owner decides to grant access to, or transfer, the vault contents to one or more designated beneficiaries. UI 150 further gives the owner the ability to set up a vault transfer to a designated beneficiary by selecting the vault transfer icon. Upon selection of the vault transfer icon, the vault transfer engine 110 (FIG. 1) guides the user through the steps to set up a beneficiary of the owner's vault, as well as the condition(s) under which the beneficiary will be granted access to the owner's vault. The operation of the vault transfer engine 110 will now be explained with reference to the flowcharts of FIGS. 3 and 4.

Upon selection of the vault transfer icon 152, the first step 200 performed by the vault transfer engine 110 is to set up a vault transfer beneficiary named by the vault owner. Further details of step 200 will now be explained with reference to the flowchart of FIG. 4. In step 230, the vault transfer engine 110 looks for selection of the vault transfer icon 152. Upon detection of selection of the vault transfer icon 152, the vault transfer engine 110 prompts the owner to provide the beneficiary name and contact information and, possibly, relation to the owner in step 232. This information may be provided by the owner via a user interface displayed to the owner on the client device 142.

In step 234, the vault owner is prompted to provide one or more conditions under which the vault is to transfer to the beneficiary. The most common condition may be upon the death of the owner, but may alternatively or additionally be upon incapacitation of the owner or some other owner-defined condition. Again, this information may be provided by the owner we a user interface displayed to the owner and the client device 142.

The vault transfer engine 110 a next attempt to contact the beneficiary step 236, using the contact information provided by the owner. This is to make sure a beneficiary is properly identified and located. The beneficiary may be prompted in step 236 2 reply to confirm receipt of the beneficiary designation. In step 238, if the beneficiary does not confirm receipt, the owner may be alerted in step 240, and the owner may be prompted to enter new beneficiary contact information returning to step 230.

On the other hand, if the beneficiary confirms receipt in step 238, the beneficiary may be prompted in step 242 to download the digital vault at their own client device to complete registration. The owner-defined beneficiary and vault transfer conditions may be stored in memory 106 of the digital vault server 102 in step 244. The owner they set up as beneficiaries as the owner wishes.

The vault transfer engine 110 may further be responsible for granting one or more beneficiaries access to the owner's vault contents upon satisfaction of the owner's predefined transfer condition. Returning to the flowchart of FIG. 3, the vault transfer engine 110 looks in step 202 as to whether a vault transfer condition has been satisfied. It is noted that until such time as a vault transfer condition has been satisfied, a vault owner may modify beneficiaries and/or transfer conditions in step 200 as described above. It is also noted that all beneficiaries may have the same vault transfer condition (such as death of the vault owner), or that different beneficiaries may have different vault transfer conditions so that a first beneficiary may be granted access to the vault contents before a second beneficiary.

Upon receiving notification of satisfaction of a vault transfer condition step 202, satisfaction of the condition may be verified in step 204. Steps 202 and 204 may be performed in a variety of ways. In one embodiment, a beneficiary registered with the digital vault server 102 may send notification to the digital vault server 102 and condition has been satisfied. This may occur for example where the vault owner has passed away or is incapacitated. Notification may be an automated process, or alternatively, notification may occur by a beneficiary contacting are corresponding with a live technician working in connection with the digital vault server 102.

Similarly, the verification step 204 may be an automated process with the digital vault server is able to verify they automated means the passage of the vault owner, incapacitation of the vault owner were satisfaction of some other owner-defined condition. Alternatively, the verification step may be performed by live technician working connection with the digital vault server 102. In this example, the technician may receive and review a death certificate, converse with a doctor who can confirm incapacitation, or perform some other action verifying satisfaction of the transfer condition independently of notification from the beneficiary.

In step 206, all beneficiaries for whom the transfer condition has been satisfied are notified that the vault transfer has occurred and that they now have access to the owner's digital vault. In step 210, the vault transfer engine 110 checks whether the beneficiary provides login or access credentials. If a beneficiary does not respond to step 210, other vault beneficiaries may be notified in step 212 to verify the non-responding beneficiary's contact information.

Assuming beneficiary response in step 210, the entered credentials are verified by the vault transfer engine 110 in step 214. Assuming the credentials match the stored verification information for beneficiary, the beneficiary is granted vault access in step 216 and the beneficiary may open the owner's vault in step 218. At this point, the beneficiary may view all contents of the owner's vault which the owner has built up and saved for the beneficiary.

On the other hand, if the beneficiary enters incorrect credentials in step 214, the vault transfer engine 110 checks whether some predefined maximum number of verification attempts has been reached in step 220. If not, the beneficiary is prompted to reenter their access credentials in step 210. On the other hand, predefined maximum number of verification attempts has been reached in step 220, some independent verification of the beneficiaries are formed in step 224 to ensure that the owner intended for this beneficiary to be granted access to the vault. Step 224 may be performed for example by a technician working in connection with the digital vault server 102.

In embodiments, once granted access, vault beneficiaries may be taken to an online homepage where the vault beneficiary may explore what has been left to them by the owner. In embodiments, a vault owner may customize the look and feel of that homepage. In further embodiments, the vault owner may customize the look and feel of that homepage to individual beneficiaries.

FIG. 5 illustrates an exemplary computing system 300 that may be server 102 or server used to implement an embodiment of the present technology. The computing system 300 of FIG. 5 includes one or more processors 310 and main memory 320. Main memory 320 stores, in part, instructions and data for execution by processor unit 310. Main memory 320 can store the executable code when the computing system 300 is in operation. The computing system 300 of FIG. 5 may further include a mass storage device 330, portable storage medium drive(s) 340, output devices 350, user input devices 360, a display system 370, and other peripheral devices 380.

The components shown in FIG. 5 are depicted as being connected via a single bus 390. The components may be connected through one or more data transport means. Processor unit 310 and main memory 320 may be connected via a local microprocessor bus, and the mass storage device 330, peripheral device(s) 380, portable storage medium drive(s) 340, and display system 370 may be connected via one or more input/output (I/O) buses.

Mass storage device 330, which may be implemented with a magnetic disk drive or an optical disk drive, is a non-volatile storage device for storing data and instructions for use by processor unit 310. Mass storage device 330 can store the system software for implementing embodiments of the present invention for purposes of loading that software into main memory 320.

Portable storage medium drive(s) 340 operate in conjunction with a portable non-volatile storage medium, such as a external hard drive, external SSD or USB stick, to input and output data and code to and from the computing system 300 of FIG. 5. The system software for implementing embodiments of the present invention may be stored on such a portable medium and input to the computing system 300 via the portable storage medium drive(s) 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 5 includes output devices 350. Suitable output devices include speakers, printers, network interfaces, and monitors. Where computing system 300 is part of a mechanical client device, the output device 350 may further include servo controls for motors within the mechanical device.

Display system 370 may include a liquid crystal display (LCD) or other suitable display device. Display system 370 receives textual and graphical information, and processes the information for output to the display device.

Peripheral device(s) 380 may include any type of computer support device to add additional functionality to the computing system. Peripheral device(s) 380 may include a modem or a router.

The components contained in the computing system 300 of FIG. 5 are those typically found in computing systems that may be suitable for use with embodiments of the present invention and are intended to represent a broad category of such computer components that are well known in the art. Thus, the computing system 300 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, MacOS, FreeBSD, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, an SSD, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

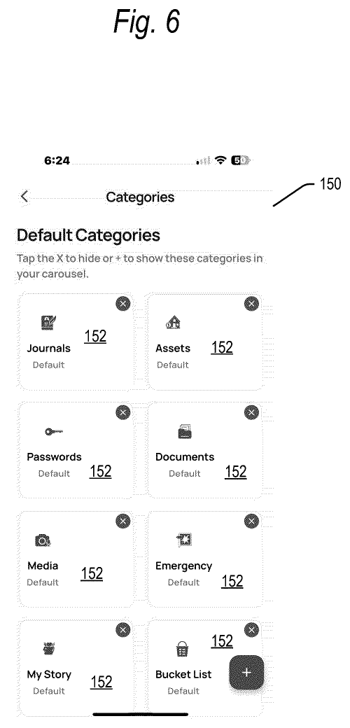

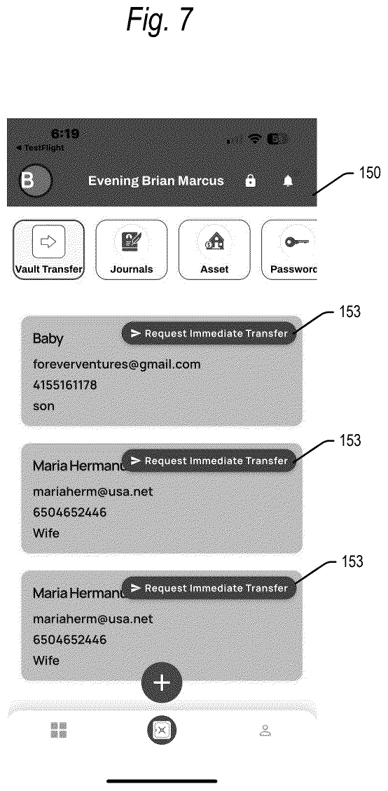

FIGS. 6-23 illustrate examples of user interface screen shots of the present technology as presented on a user device such as a smart phone. FIG. 6 illustrates a home screen user interface 150 including icons 152 described above. FIG. 7 is a user interface 150 of vaults that a user has set up. As described above and below, a user sets up the conditions which must be satisfied before his/her vault transfers, such as for example upon death or incapacitation. However, in embodiments, the user may override those conditions and immediately transfer a vault to a beneficiary. FIG. 7 includes buttons 153 which will override the defined transfer conditions and immediately initiate the transfer process.

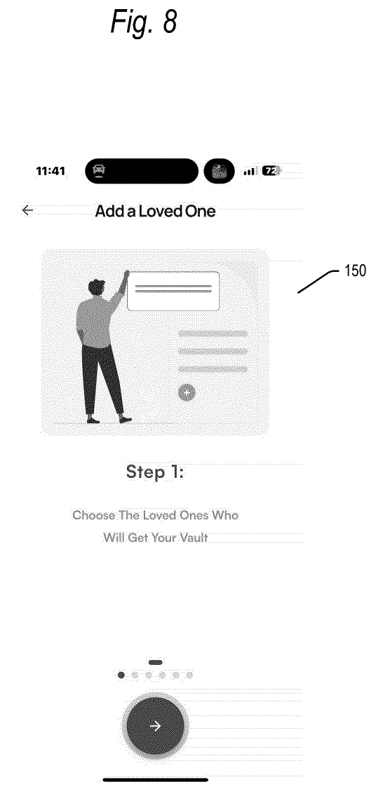

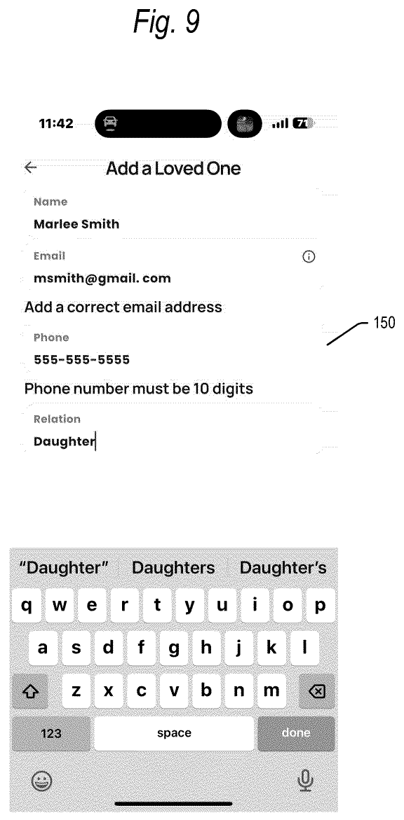

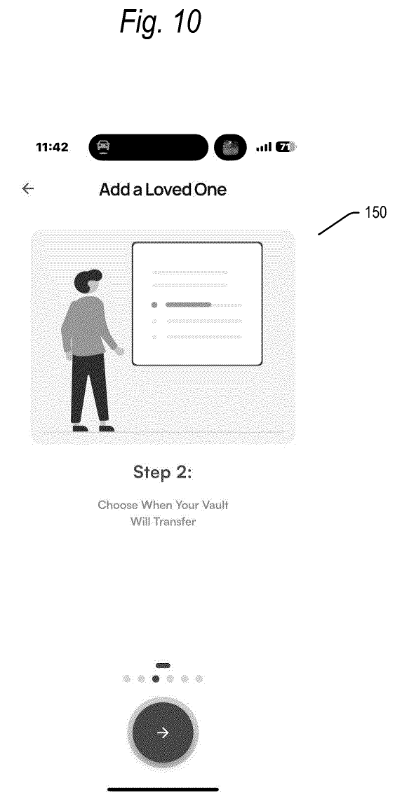

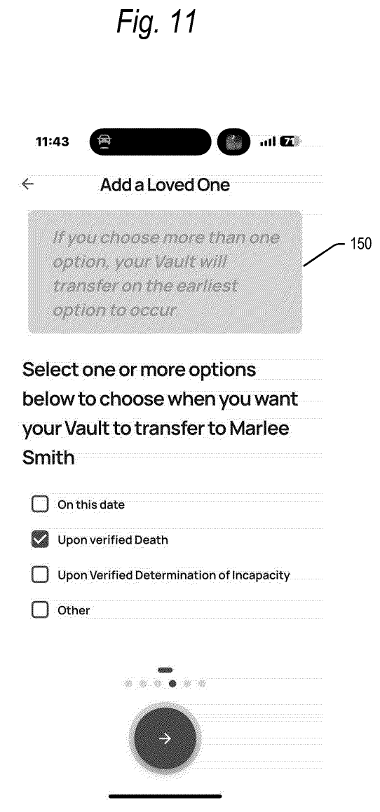

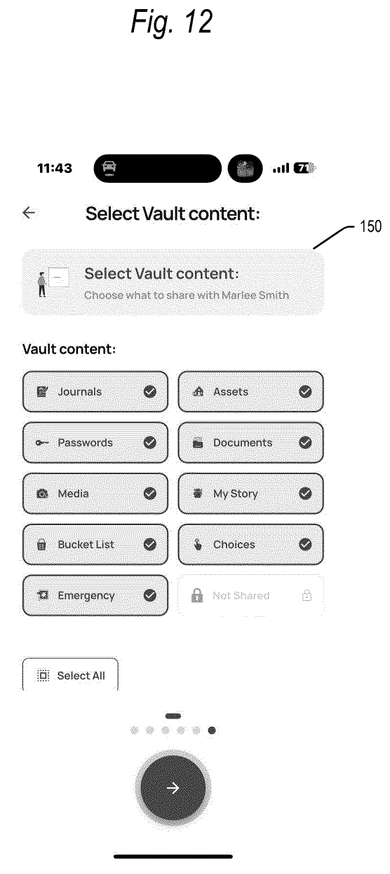

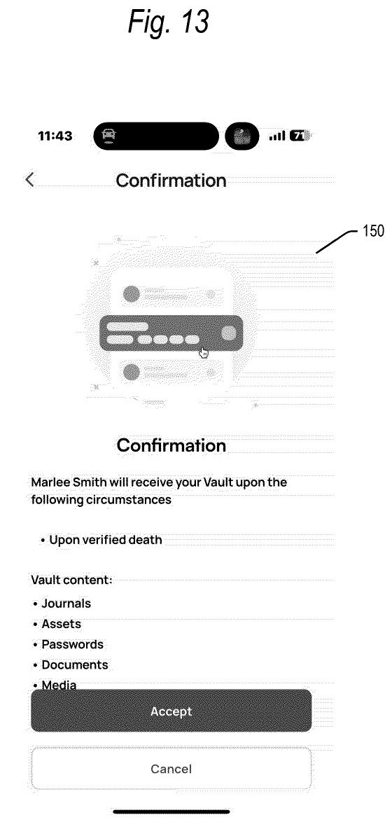

FIGS. 8-13 show screen user interfaces 150 for setting up a vault for a beneficiary. FIG. 8 shows an instruction screen for adding information on a new beneficiary. FIG. 9 allows a user to enter the beneficiary information. FIG. 10 shows instructions on a second step of choosing when the vault is to transfer. FIG. 11 allows the user to make that selection. FIG. 12 allows a user to define which portions of a vault are to transfer to the beneficiary (a user can transfer all or less than all of his/her vault). FIG. 13 is a confirmation screen.

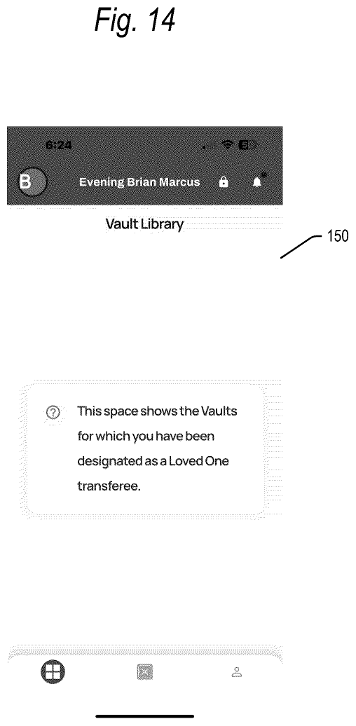

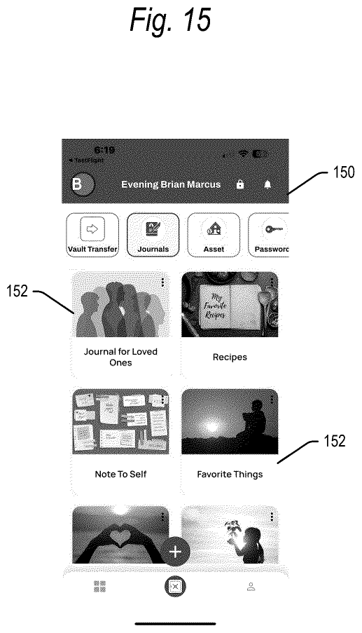

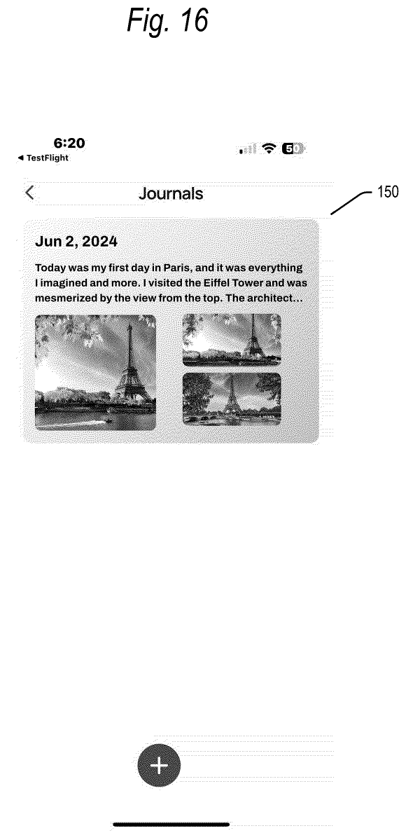

FIG. 14 is a user interface 150 of vaults that have been set up by others for the user and have been transferred to the user. FIG. 15 is a user interface 150 showing various types of journals that a user can create. Each icon 152 brings the user to a new screen where the user can create content. FIG. 16 illustrates one such user interface page 150 where a user as journaled about his/her travels. A wide variety of other journals are possible.

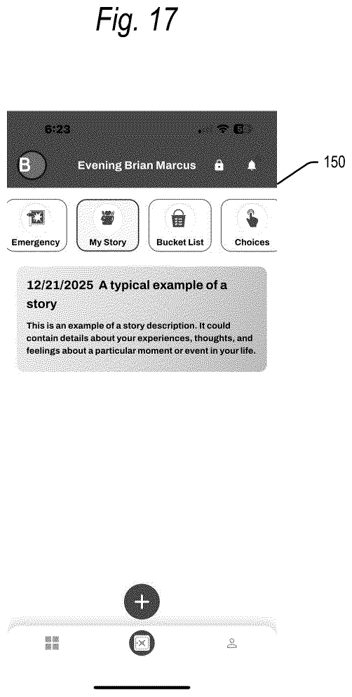

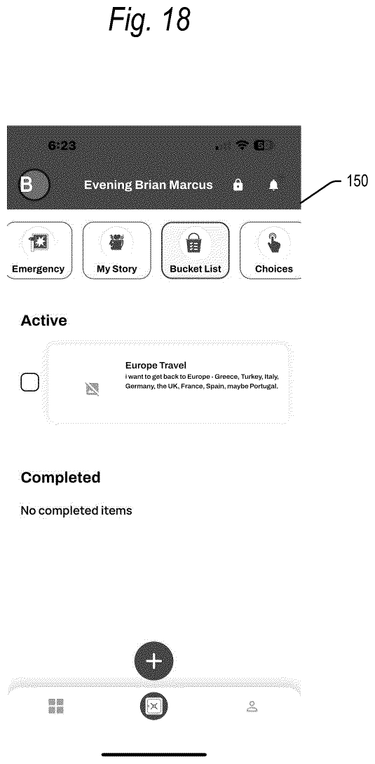

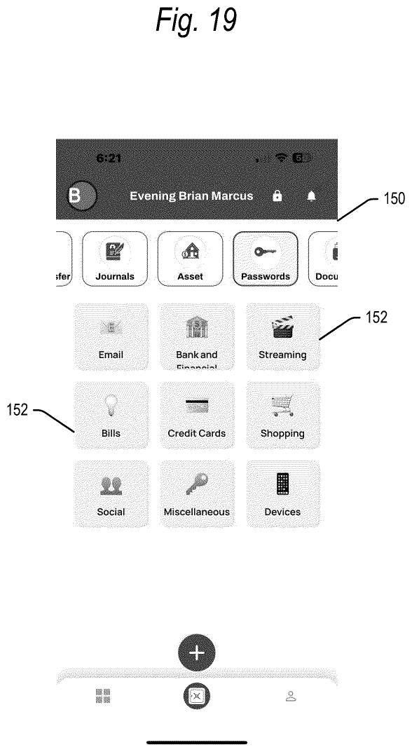

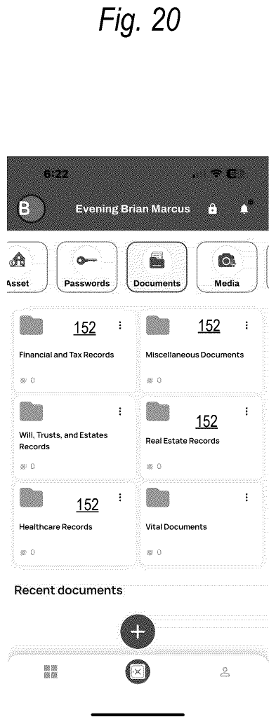

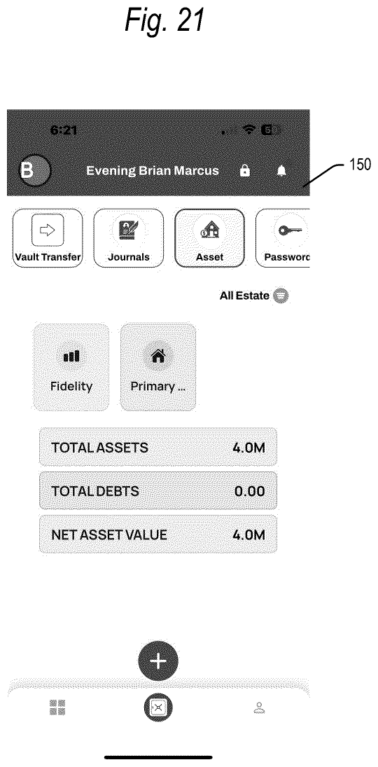

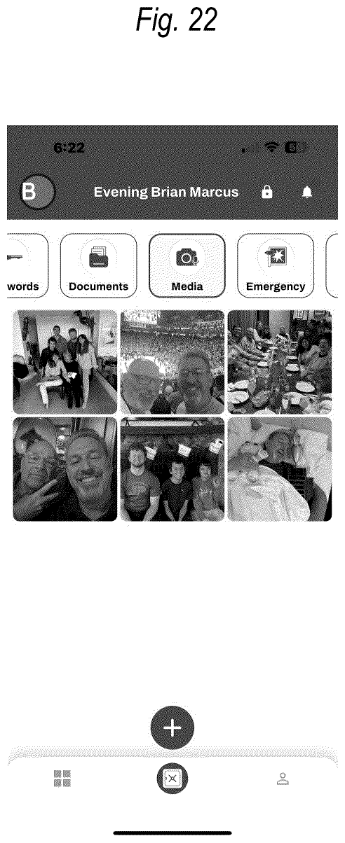

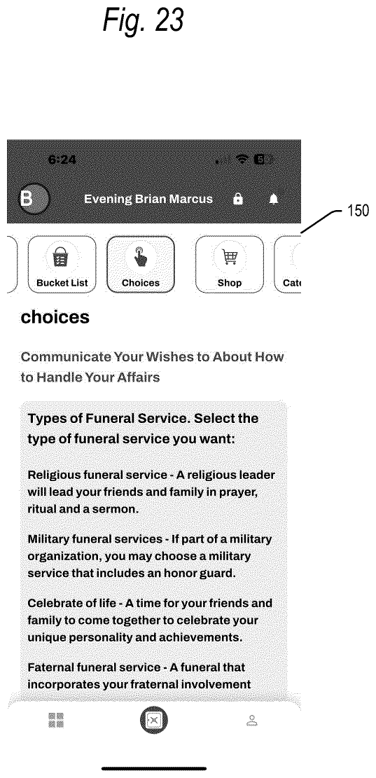

FIG. 17 is a ‘my story’ user interface 150 where a user can write about their life story and experiences. FIG. 18 is a ‘bucket list’ user interface 150 where a user can list their bucket list items. FIG. 19 is a passwords user interface 150 where a user can store his/her passwords associated with different applications indicated by the different icons 152. FIG. 20 is a user interface allowing a user to store his/her important documents. The interface presents different icons 152 for different classes of documents. One example is shown in the user interface 150 of FIG. 21. FIG. 22 is a media user interface where a user can upload or otherwise store his/her media such as photos, videos, audio files, etc. FIG. 23 is a user interface 150 where a user can specify his or her choices or preferences for his/her affairs upon passing or becoming incapacitated.

In summary, one embodiment of the present technology relates to a system for storing information in a secure digital location to be passed to one or more beneficiaries, the system comprising: a storage memory for storing one or more programs and data; one or more processors for executing the one or more programs stored in memory to: enable storage in the storage memory of data relating to practical information about an individual, enable storage in the storage memory of data relating to personal information about in individual, enable the setup of conditions determining when the one or more beneficiaries will gain access to the data stored in the storage memory, and allowing access by the one or more beneficiaries upon satisfaction of the condition.

In another example, the present technology relates to a computer-implemented method for storing information in a secure digital vault for transfer to one or more beneficiaries, the method comprising: receiving, via a graphical user interface, one or more of practical information relating to an individual and personal information relating to the individual; storing, in a storage memory of a digital vault, the practical information and/or the personal information; receiving, from the individual, beneficiary information identifying one or more beneficiaries; receiving, from the individual, one or more transfer conditions indicating when the one or more beneficiaries will be provided access to the stored practical information and personal information; monitoring for satisfaction of the one or more transfer conditions; and granting the one or more beneficiaries access to the stored practical information and/or personal information in response to verifying satisfaction of the one or more transfer conditions.

In a further example, the present technology relates to a system for transferring digital vault contents to one or more beneficiaries, the system comprising: a storage memory storing encrypted digital vault contents associated with an individual; and one or more processors configured to execute a vault transfer engine programmed to: (a) receive beneficiary identity and contact information from the individual, (b) transmit a confirmation request to the beneficiary and receive a confirmation response from the beneficiary, (c) store one or more transfer conditions defining when the beneficiary is to be granted access to the digital vault contents, (d) verify satisfaction of the one or more transfer conditions independent of beneficiary notification, and (e) upon verifying satisfaction of the one or more transfer conditions, grant the beneficiary access to the encrypted digital vault contents by validating access credentials supplied by the beneficiary.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

We claim:

1. A system for storing information in a secure digital location to be passed to one or more beneficiaries, the system comprising:
a storage memory for storing one or more programs and data;
one or more processors for executing the one or more programs stored in memory to:
enable storage in the storage memory of data relating to practical information about an individual,
enable storage in the storage memory of data relating to personal information about in individual,
enable the setup of conditions determining when the one or more beneficiaries will gain access to the data stored in the storage memory, and
allowing access by the one or more beneficiaries upon satisfaction of the condition.

2. The system of claim 1, wherein the practical information relates to one or more of financial information, wills, trusts and assets of the individuals.

3. The system of claim 1, wherein the personal information relates to one or more of journals and multimedia relating to the individual's thoughts, reflections, desires and advice for the one or more beneficiaries.

4. The system of claim 1, wherein the stored data includes passwords associated with one or more user accounts.

5. The system of claim 1, wherein the storage memory includes a plurality of datastores comprising at least a plurality of a journal datastore, a documents datastore, a media datastore, an assets datastore, a my story datastore, and a bucket list datastore.

6. The system of claim 1, wherein the one or more processors are further configured to encrypt the stored data using a user-specific encryption key.

7. The system of claim 1, wherein allowing access by the one or more beneficiaries comprises verifying beneficiary identity based at least in part on credentials entered by the beneficiary.

8. The system of claim 1, wherein the personal information stored in the storage memory comprises one or more of photos, videos, and audio files uploaded by the individual.

9. The system of claim 1, wherein enabling storage of personal information further comprises enabling the use of artificial intelligence to generate a personal story of the individual based on data stored in the storage memory.

10. The system of claim 1, wherein enabling the setup of conditions determining beneficiary access further comprises transmitting beneficiary contact information to the one or more beneficiaries and receiving confirmation from the one or more beneficiaries prior to vault transfer.

11. A computer-implemented method for storing information in a secure digital vault for transfer to one or more beneficiaries, the method comprising:
receiving, via a graphical user interface, one or more of practical information relating to an individual and personal information relating to the individual;
storing, in a storage memory of a digital vault, the practical information and/or the personal information;
receiving, from the individual, beneficiary information identifying one or more beneficiaries;
receiving, from the individual, one or more transfer conditions indicating when the one or more beneficiaries will be provided access to the stored practical information and personal information;
monitoring for satisfaction of the one or more transfer conditions; and
granting the one or more beneficiaries access to the stored practical information and/or personal information in response to verifying satisfaction of the one or more transfer conditions.

12. The computer-implemented method of claim 11, further comprising the step of encrypting the stored practical information and/or personal information using a user-specific encryption key.

13. The computer-implemented method of claim 12, wherein the step of encrypting the stored practical information and/or personal information using a user-specific encryption key comprises generating the user-specific encryption key from a user seed stored locally on a client device associated with the individual.

14. The computer-implemented method of claim 11, wherein storing the practical information and/or personal information comprises storing journals, financial documents, passwords, and multimedia files in one or more datastores within the storage memory.

15. The computer-implemented method of claim 11, wherein storing the practical information and/or personal information comprises storing journals, financial documents, passwords, and multimedia files in one or more datastores within the storage memory.

16. The computer-implemented method of claim 11, further comprising receiving confirmation from the one or more beneficiaries acknowledging designation prior to granting access to the stored practical information and personal information.

17. The computer-implemented method of claim 11, wherein the step of granting the one or more beneficiaries access to the stored practical information and/or personal information in response to verifying satisfaction of the one or more transfer conditions occurs automatically upon verifying satisfaction of the one or more transfer conditions.

18. A system for transferring digital vault contents to one or more beneficiaries, the system comprising:
a storage memory storing encrypted digital vault contents associated with an individual; and
one or more processors configured to execute a vault transfer engine programmed to:
(a) receive beneficiary identity and contact information from the individual,
(b) transmit a confirmation request to the beneficiary and receive a confirmation response from the beneficiary,
(c) store one or more transfer conditions defining when the beneficiary is to be granted access to the digital vault contents,
(d) verify satisfaction of the one or more transfer conditions independent of beneficiary notification, and
(e) upon verifying satisfaction of the one or more transfer conditions, grant the beneficiary access to the encrypted digital vault contents by validating access credentials supplied by the beneficiary.

19. The system of claim 18, wherein said step (d) of verifying satisfaction of the one or more transfer conditions occurs automatically.

20. The system of claim 18, wherein said step (d) of verifying satisfaction of the one or more transfer conditions occurs manually.
